(19) United States
(12) Patent Application Publication
(10) Pub. No.: US 2023/0072997 A1
(43) Pub. Date: Mar. 9, 2023

(54) INTELLIGENT HORIZONTAL TRANSPORTATION SYSTEM AND METHOD FOR AUTOMATIC SIDE-LOADING/UNLOADING CONTAINER TARMINAL

(71) Applicant: Tianjin Port Second Container Terminal Co., Ltd., Tianjin (CN)

(72) Inventors: Bin CHU, Tianjin (CN); Guangjun JIAO, Tianjin (CN); Jiemin YANG, Tianjin (CN); Rong YANG, Tianjin (CN); Yanhui GAO, Tianjin (CN); Pei CHEN, Tianjin (CN); Bin WU, Tianjin (CN); Kai ZHANG, Tianjin (CN); Xiwang LIU, Tianjin (CN); Weiyu NING, Tianjin (CN); Jiawei TANG, Tianjin (CN); Miao FENG, Tianjin (CN); Pai PENG, Tianjin (CN); Qiu LI, Tianjin (CN)

(21) Appl. No.: 17/941,007

(22) Filed: Sep. 8, 2022

(30) Foreign Application Priority Data
Sep. 8, 2021 (CN) 202111046886.X

(51) Int. Cl. G01C 21/34; G05B 13/02; G06Q 10/04; G06Q 10/08; G06Q 10/06

(52) U.S. Cl. CPC G01C 21/3492; G05B 13/0265; G06Q 10/047; G06Q 10/06315; G06Q 10/08355

(57) ABSTRACT

The disclosure provides an intelligent horizontal transportation system for a completely automatic side-loading/unloading container terminal. The system includes a horizontal transportation device including an unmanned artificial intelligence robot of transportation (ART) and a horizontal transportation control system that intelligently manages and controls the ART to enable it to complete horizontal transportation. The horizontal transportation control system is in real-time connection and communication with a terminal operation system (TOS), an automatic field crane, an automatic shore crane and the ART to complete information interactive processing to realize information interconnection, so as to guarantee real-time utilization of information and intelligent control of the ART. The horizontal transportation control system realizes intelligent management and control of the horizontal transportation device by executing the following functions.

### CROSS-REFERENCE TO RELATED APPLICATIONS

Pursuant to 35 U.S.C.§ 119 and the Paris Convention Treaty, this application claims foreign priority to Chinese Patent Application No. 202111046886.X filed Sep. 8, 2021. The contents of all of the aforementioned applications, including any intervening amendments thereto, are incorporated herein by reference. Inquiries from the public to applicants or assignees concerning this document or the related applications should be directed to: Matthias Scholl PC., Attn.: Dr. Matthias Scholl Esq., 245 First Street, 18th Floor, Cambridge, MA 02142.

### BACKGROUND

The disclosure belongs to the field of terminal transportation control, and particularly relates to an intelligent horizontal transportation system and method for a completely automatic loading/unloading container terminal.

As a key link of a container transportation network, the efficiencies for containers loading/unloading and transportation of a container terminal decide the economic benefit of the whole flow of container transportation, which significantly manifests the core competitiveness of a harbor. Compared with a conventional terminal, an automatic container terminal featuring high efficiency, environmental protection, low labor cost and the like has become an inevitable trend for future development of the container terminal. A shore crane, an ART (Artificial Intelligence Robot of Transportation) and a yard crane are primary devices in loading, unloading and transportation processes of the automatic container terminal, and are interrelated each other. The shore crane is located at the front edge of the terminal and is responsible for loading and unloading containers on a ship, and its efficiency decides the residence time of the ship at the harbor.

The cooperative operation efficiency of the shore crane, the ART and the yard crane of an existing comprehensive container terminal is ordinary, and the technical level of container handling at the shore crane remains to be improved.

### SUMMARY

The objective of the disclosure is to provide an intelligent horizontal transportation system and method for a completely automatic side-loading/unloading container terminal. By means of the intelligent horizontal transportation system, an automatic horizontal transportation vehicle can be adaptive to the demands of various types of operations at the terminal and is in real-time interaction with other systems to complete information transmission and utilization, so that the real-time perceiving and processing abilities of an overall operation system of the terminal are improved.

In one aspect, the disclosure provides an intelligent horizontal transportation system for a completely automatic side-loading/unloading container terminal, including a horizontal transportation device named artificial intelligence robot of transportation (ART) and a horizontal transportation control system that intelligently manages and controls the ART to enable the ART to complete horizontal transportation. The horizontal transportation control system is in real-time connection and communication with a terminal operation system (TOS), an automatic yard crane, an automatic shore crane and the ART to complete information interactive processing to realize information interconnection, so as to guarantee real-time utilization of information and intelligent control of the ART; the horizontal transportation control system realizes intelligent management and control of the horizontal transportation device by executing the following functions:

intelligent task scheduling: based on a horizontally arranged side-loading process, assigning an operating task to the horizontal transportation device in combination with a horizontal transportation operational plan comprising shipping and unshipping and container shifting, and a real-time position of the horizontal transportation device by taking the shortest global operating time and the shortest global operating path as the principle: first, generating a preliminary vehicle transportation path and a time schedule based on the principle of the shortest global operating time; and then correcting a part of path plan by applying the principle of the shortest global operating path, which reduces road congestion in a harbor district and finally realizes the optimum operating efficiency;

dynamic path planning: based on the horizontally arranged side-loading/ unloading process, constructing a terminal road topological structure by utilizing a high definition map technology, planning a driving path of an operating vehicle in real time by applying a dynamic path planning algorithm in combination with real-time road information and kinematics characteristics: wide-angle turning and crab walk passing of the horizontal transportation device, and realizing vehicle-vehicle cooperation in a mode that combines global path planning and local refined guiding to solve a traffic deadlock problem, so as to ensure stable and orderly horizontal transportation;

control interface standardizing: defining a standard interface based on an unmanned industry criterion to realize a decoupling design of the horizontal transportation device and the system, being compatible with the horizontal transportation device with different kinematics characteristic in an unmanned technical route through the standard interface, and realizing real-time communication by adopting an MQTT (Message Queuing Telemetry Transport) communication protocol base of the Internet of things;

intelligent traffic management: sensing the positions and the number of outer container trucks by utilizing a vehicle infrastructure cooperation technology, positioning the horizontal transportation device inside in real time and predicting the position of the horizontal transportation device inside through a Beidou high precision positioning technology, and realizing spatial and temporal isolation of inside and outside vehicles through a multi-priority dynamic management and control strategy to realize intelligent traffic management of intersections of land transportation and shipping, so as to guarantee the operating safety;

intelligent twist lock station management and control: based on a ground centralized lock disassembling and assembling process, performing one-key configuration on the number and positions of twist lock stations in combination with docking positions and a lock disassembling and assembling task load, automatically generating a lock disassembling and assembling task list according to historical operating data of ships, and selecting the optimum lock island through a dynamic allocation algorithm to avoid congestion of the lock island, so as to ensure the lock disassembling and assembling operating efficiency; meanwhile, based on an intelligent safety management and control mechanism carried in a ground lock station, performing integral isolation of an automatic operation and a manual operation, so as to guarantee a safe and reliable lock disassembling and assembling operation;

intelligent vehicle reordering: based on a three-level horizontally arranged dynamic buffer area process, regulating and controlling a sequential order of all horizontal transportation operating vehicles by utilizing advance scientific decision-making, interim differential control and post-operational temporary buffering in combination of a requirement on an actual shipping pattern, so as to guarantee that the transportation vehicles arrive an operating area of the shore crane according to a regulated operating order for orderly shipping operations;

intelligent charging scheduling: based on a centralized lateral side charging pattern, performing real-time decision-making on charging opportunity and charging duration by utilizing a hierarchical dynamic charging scheduling strategy in combination with demands on transport capacity and power of a container horizontal transportation operation on the premise of fully considering mass charge-discharge balance, and selecting a charging pile in combination with the kinematics characteristics of the horizontal transportation device, and realizing automatic alignment and automatic charging control through a constructed charging pile device management platform, so as to ensure that overall power of the horizontal transportation vehicle is continuous and stable;

intelligent parking management: based on the horizontally arranged side loading and unloading process, dynamically arranging parking areas to fully utilize physical spaces in combination with a berth plan and a seaside loading and unloading ship operating plan, and dynamically distributing the parking areas and the parking positions in combination with the kinematics characteristics and future possible operating tasks of the vehicles to meet a fast attendance requirement, so as to improve the utilization ratios of the transportation vehicles and shorten the task waiting times; and

intelligent remote driving: defining a standard control interface, being compatible with the horizontal transportation devices with different kinematics characteristics through the standard interface, realizing remote real-time supervision and control of the intelligent horizontal transportation devices by a remote console based on the 5G high bandwidth and low delay ability, and realizing one-to-many remote driving supervision and monitoring of the horizontal transportation devices through the remote console.

In another aspect, the disclosure provides an intelligent horizontal transportation method for a completely automatic side-loading/unloading container terminal using the intelligent horizontal transportation system, including the following steps:

S1: acquiring terminal road information by a horizontal transportation control system by using a high precision mobile measurement device, manufacturing a base map of a high precision map of a terminal, and constructing dynamic layers and keeping real-time update, so as to provide a basic environment for ART path planning and real-time monitoring;

S2: assigning operation tasks to the horizontal transportation device in combination with a horizontal transportation operational plan comprising shipping and unshipping and container shifting, and a real-time position of the horizontal transportation device by the horizontal transportation control system by taking the shortest global operation time and the shortest global operation path as the principle;

S3: generating, by the horizontal transportation control system, a real-time task path for the horizontal transportation device based on a dynamic path planning algorithm, determining the starting points and the endpoints of transportation tasks, realizing vehicle-vehicle cooperation in a key area by utilizing an interval vehicle control technology, and controlling a traffic deadlock of a key path;

S4: connecting the horizontal transportation device to the horizontal transportation control system through a standardized control interface, reporting the position and state of the horizontal transportation device itself, and receiving an operation task and a driving path;

S5: in a vehicle driving process, performing, by the horizontal transportation control system, dynamic path planning and speed adjustment on a vehicle based on the high precision map data of the terminal, the real-time position, the driving speed and the priority data of the vehicle, and meanwhile, autonomously completing obstacle avoiding, speed controlling and parking actions by utilizing sensing devices comprising vehicle-mounted radar and a monocular camera to avoid risks initiatively, so as to complete the horizontal transportation task according to a regulated time and location;

S6: when the horizontal transportation device drives to a passing intersection of the outer container trucks located at entrance and exit of a storage yard, perceiving the number and positions of the inner and outer container trucks in real time, and performing real-time decision-making on a passing order of the vehicles based on a multipriority passing management and control strategy;

S7: when the horizontal transportation device advances for a lock station assembling and disassembling operation, assigning corresponding lock stations and front buffering areas for operation vehicles according to real-time working states of the lock stations, and meanwhile, planning driving paths of the vehicles in a lock station area, and ensuring safe operations in the lock assembling and disassembling processes by utilizing a safety management and control strategy;

S8: after completing the lock assembly and disassembly, scheduling, by the horizontal transportation control system, the horizontal transportation device to operation positions of a shore crane or the storage yard for shipping and unshipping operations, and when there are other vehicles in the operation positions, assigning, by the horizontal transportation control system, temporary waiting positions;

S9: during executing the horizontal transportation task or after completing the horizontal transportation task, evaluating whether the ART needs to be charged according to a hierarchical dynamic charging scheduling strategy, and if necessary, enabling, by a charging system, the ART to be automatically offline after completing the task, and automatically recovering the ART to be online after assigning charging piles to execute lateral side charging completely, so as to participate in the horizontal transportation operation continuously;

S10: when the vehicle completes the current operation task and has no subsequent planned tasks, assigning, by the horizontal transportation control system, the parking areas and the parking lots in combination with demands on a subsequent operation plan and fast attendance, and enabling the ART to be automatically offline;

S11: in all-weather dynamic monitoring of the intelligent transportation vehicles, realizing, by the horizontal transportation control system, in-time management and remote operation and control of special working conditions and abnormal states of the vehicles based on an intelligent task management and remote driving mode.

The intelligent horizontal transportation system provided by the disclosure can be in real-time connection and communication with sub-systems such as a TOS (Terminal Operation System), an automatic yard crane, an automatic shore crane and an intelligent horizontal transportation device to complete interaction of information, and completes real-time transfer and fusion through interconnection, thereby guaranteeing real-time utilization of information and intelligent control of the horizontal transportation device.

To solve a behavior boundary problem between the system and the horizontal transportation device, a key interval is defined from the God’s perspective of the intelligent horizontal transportation system by utilizing a mode that combines global path planning with interval vehicle control; a suggested speed, a time window and the maximum range in an allowable deviation of the key interval are set in combination with the kinematics characteristics of the single vehicle to solve the traffic deadlock problem in the key area such as the intersections of the paths while giving full play of intelligence of the single vehicle.

The intelligent transportation system provided by the disclosure realizes a decoupling design of the system and the single horizontal transportation vehicle by defining the standardized control interface, forges an open ecosystem to effectively reduce the dot matrix density and greatly reduce the communication pressure of the network, and is combined with the kinematics characteristics of the vehicle to effectively reduce the deadlock problem of the key path point, so as to further optimize the vehicle merging driving ability. A balance point is run between the global path plan and the single vehicle intelligence. To realize a long-term operation target and give play to the single vehicle to reserve an infinite space, dependent on features of the horizontally arranged loading and unloading process, an automatic driving technical route with generalizability is created.

Compared with a conventional horizontal transportation device management mode, the disclosure processes and adjusts the horizontal transportation operation according to real-time condition information in assigning horizontal transportation tasks of the terminal, thereby guaranteeing smoothness of harbor work and reducing congestion. The disclosure makes the horizontal transportation management flow fully automatic, realizes sustainable operation of the operation system, based on gray level update, multiple protection and a fault recovery mechanism of the system, and adjust the operation plan of the device according to real-time operation data of the harbor, so as to improve the operation efficiency of the whole horizontal transportation system. Meanwhile, the disclosure breaks through the conventional mode to realize the decoupling design of the horizontal transportation device and the system for the first time, is compatible with various different types of horizontal transportation devices through the standard interface, and constructs the open ecosystem, so as to promote unmanned driving technology with high quality in the industry of automatic container terminal.

### DESCRIPTION OF DRAWINGS

FIG. 1 is a structural diagram of a control system of an intelligent horizontal transportation system for a completely automatic side-loading/unloading container terminal provided by an embodiment of the disclosure.

FIG. 2 is a flowchart of an intelligent horizontal transportation method for a completely automatic side-loading/unloading container terminal provided by an embodiment of the disclosure.

FIG. 3 is a design brief diagram of an intelligent horizontal transportation system for a completely automatic side-loading/unloading container terminal provided by an embodiment of the disclosure.

FIG. 4 is a dynamic path planning schematic diagram of an ART in an unstructured scenario provided by an embodiment of the disclosure.

FIG. 5 is a schematic diagram of multiple vehicle cooperation of the ARTs provided by an embodiment of the disclosure.

FIG. 6 is a refined guiding schematic diagram of a specific action of an ART in an allowed deviation range provided by an embodiment of the disclosure.

FIG. 7 is an autonomous path planning schematic diagram of an ART in a straight angle steering scenario provided by an embodiment of the disclosure.

FIG. 8 is an autonomous path planning schematic diagram of an ART in a multiple obstacle avoidance scenario and the like provided by an embodiment of the disclosure.

### DETAILED DESCRIPTION OF THE INVENTION

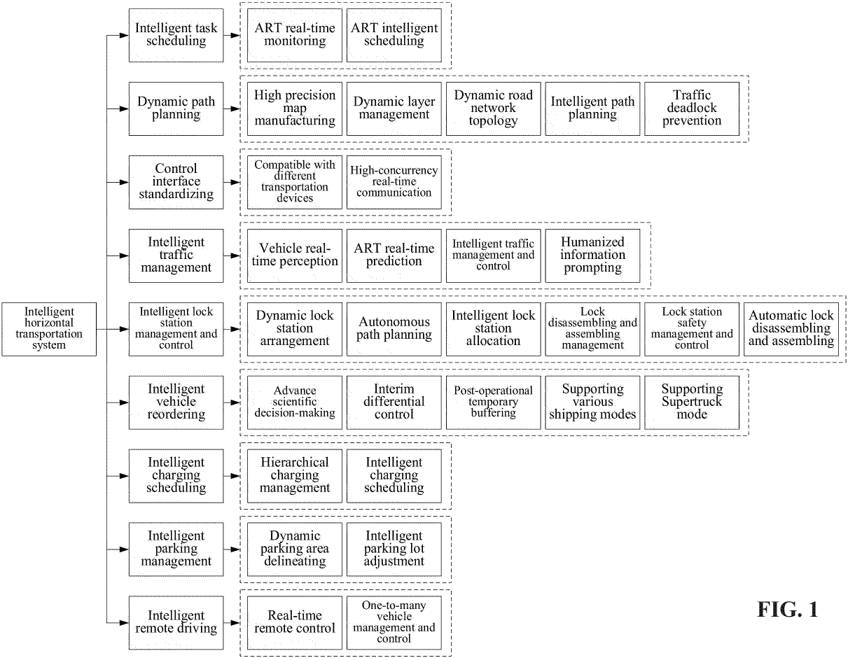

An intelligent horizontal transportation system for a completely automatic side-loading/unloading container terminal provided by the embodiment of the disclosure comprises a horizontal transportation device comprising named ART (Artificial Intelligence Robot of Transportation) and a horizontal transportation control system that intelligently manages and controls the ART to enable the ART to complete horizontal transportation. The horizontal transportation control system is in real-time connection and communication with a TOS (Terminal Operation System), an automatic yard crane, an automatic shore crane and the ART to complete information interactive processing to realize information interconnection, so as to guarantee real-time utilization of information and intelligent control of the ART; as shown in FIG. 1, the horizontal transportation control system realizes complete intelligent control of the horizontal transportation device by executing the following functions to complete the horizontal transportation task:

P1: intelligent task scheduling: based on a horizontally arranged side-loading process, an operation task is assigned to the horizontal transportation device in combination with a horizontal transportation operational plan comprising shipping and unshipping and container shifting and the like, and a real-time position of the horizontal transportation device by taking the shortest global operation time and the shortest global operation path as the principle: first, a preliminary vehicle transportation path and a time schedule are generated based on the principle of the shortest global operation time; and then a part of path plan is corrected by applying the principle of the shortest global operation path to reduce road congestion in a harbor district and ensure the task scheduling rationality, so as to finally realize the optimum operation efficiency;

the intelligent task scheduling has the specific functions:

P1.1: ART real-time monitoring: the horizontal transportation operational plan comprising shipping/unshipping and container shifting and the like are dynamically acquired, and the operation states, the driving positions and speeds of all ART in the harbor district in real time are monitored;

P1.2: ART intelligent scheduling: unoccupied ARTs with sufficient surplus electric quantities in the harbor district are screened, and a transportation task is assigned to each of the ARTs based on a principle of the shortest total driving time. Meanwhile, under the principle of reducing congestion of a road network in the harbor district, a route with the shortest driving distance is planned to each of ARTs;

P2: dynamic path planning:

based on the horizontally arranged loading and unloading process, a terminal road topological structure is constructed by utilizing a high definition map technology, a driving path of an operation vehicle is planned in real time by applying a dynamic path planning algorithm in combination with real-time road information and kinematics characteristics of the horizontal transportation device, and vehicle-vehicle cooperation is realized in a mode that combines global path planning and local refined guiding to effectively solve a traffic deadlock problem, so as to ensure stable and orderly horizontal transportation, where the high precision map technology specifically comprises:

P2.1: high precision map manufacturing: professional norms are acquired by using a high precision mobile measurement device, and manufacturing of a high-quality map in a dynamic complex environment of a terminal is completed based on a map generating algorithm, the traverse absolute precision reaching 20 cm in a related operation area;

P2.2: dynamic layer management: real-time dynamic map information of the terminal is integrated by taking the high precision map as a base map to construct a dynamic map management ability, a plurality of dynamic layers are increased on the base map, and information with different updating frequencies is drawn to different dynamic layers and real-time refreshing is kept to describe a dynamic traffic environment more properly, particularly, the path planning layer increased on the base map being used for describing an attribute and a passing rule of each passing area;

P2.3: dynamic road network topology: the road topological structure in the harbor district is altered as a result of the size of the ship, the berthing position, arrangement of the twist lock stations, blockage of the road and the like, the optimum topological relation of the road is constructed by utilizing a dynamic path generating algorithm meeting a site condition, the optimum path of the ART in a scenario of an unstructured harbor district is set in real time, and real-time basic road information is provided to the path generating algorithm, so as to guarantee centimeter-level vehicle cooperative management, where a manufacturing flow of the high precision map data is as follows:

P2.4: data acquisition: harbor data acquisition is performed by using the high precision mobile measurement device, comprising acquisition of data in scenarios such as the road, the twist lock stations and the storage yard;

P2.5: data processing and updating: based on the map generating algorithm and flow, adaptive to data processing in the dynamic complex environment of the terminal, the map is maintained and updated based on scaled production;

P2.6: element recognition: elements of the map are recognized based on point cloud classification and element recognition of deep learning;

P2.7: artificial verification: whether the positions and logic relations of lane lines, curbs, signal lamps, denoters, virtual roads and the like are accurate is verified;

P2.8: generation of map products which comprises a point cloud static map, a positioning base map and a high precision map.

The high precision map system of the automatic container terminal comprises a map production platform, a device information platform and a map cloud service platform. The high precision map production platform is responsible for racking data of the base map of the high precision map to the map cloud service platform, the device information platform configured to collect position data of the shore crane and the ART and report the data to the map cloud service platform, and the map cloud service platform issues specific information such as maps and navigation to the ART.

The dynamic path planning algorithm specifically comprises:

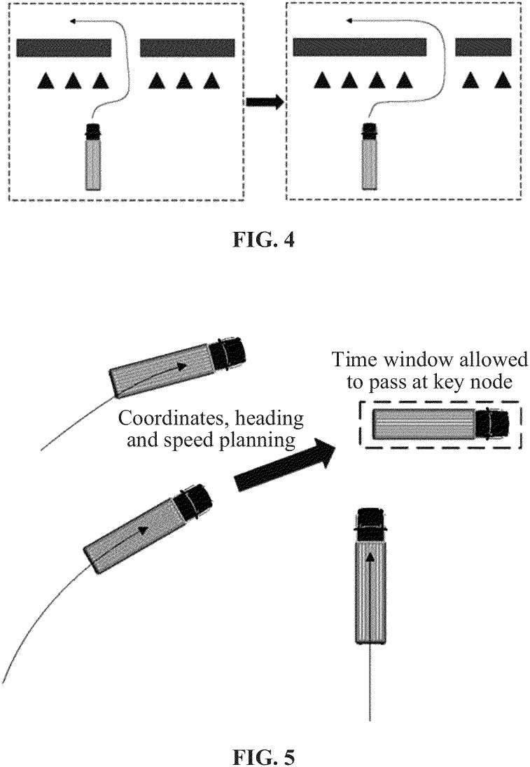

P2.9: intelligent path planning: based on the dynamic road network topological structure, a driving path is dynamically planned in real time by utilizing a spatio-temporal consistent collision-free smooth path planning algorithm in combination with the kinematics characteristics of the horizontal transportation device and traffic actuality of the horizontal transportation device. Meanwhile, to solve a behavior boundary problem between the system and the horizontal transportation device, a key interval is defined from the God’s perspective of the intelligent horizontal transportation system by combining global path planning, global path planning, global refined guiding with single vehicle execution control; a suggested speed, a time window and the maximum range in an allowable deviation of the key interval are set in combination with the kinematics characteristics of the single vehicle to solve the traffic deadlock problem in the key areas such as the intersections of the paths while giving full play of intelligence of the single vehicle, thereby creating a promotable and replicable automatic driving technical route. As shown in FIG. 4, when the optimum topological relation alters as the operation path of the ART is temporarily closed, the algorithm dynamically adjusts the topological structure of the path according to the road closure condition, so as to meet the demand on transportation operation of the ART;

the global operation scheduling refers to reasonably allocating the ARTs to execute the horizontal transportation tasks by taking the shortest overall operation time of the horizontal transportation fleet as the principle based on the actual demands on shore crane loading and unloading and storage yard horizontal transfer operations of the container terminal, so as to guarantee the consistency of operations in the links such as terminal loading and unloading and transportation, thereby improving the overall operation efficiency.

The global path planning refers to planning the global path based on the starting point and the endpoint of the task as well as random tasks such as midway unlocking and locking, homeopathic machine inspection and temporary restricted areas in combination with the kinematics characteristics of the horizontal transportation vehicles and the using principle of the road, and ensuring the shortest driving path. Based on the above-mentioned global vehicle control strategy, the spatio-temporal consistent collision-free smooth path planning algorithm that supports a multi-kinematics model generates collision-free path of the ART in scenarios such as straight lane changing and interaction turning in real time so as to ensure that the horizontal transportation task do not interfere with each other, thereby effectively reducing the deadlock problem of the key path point. As shown in FIG. 5, when there is a condition that multiple vehicles meet in the key segment of the harbor district, the algorithm, based on the ART operation priority, intelligently generates key indexes of the vehicles such as passing orders, speeds, coordinates, paths and times to realize multi-vehicle cooperative driving, so as to avoid collision and congestion.

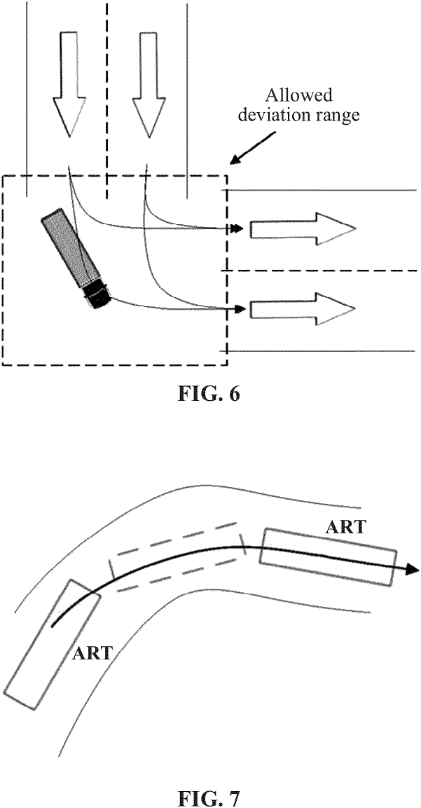

The local refined guiding refers to setting allowed deviation ranges for specific behaviors such as right-angled curves, U-shaped curves, lane changing, U-tums of the vehicle to perform refined guidance on the specific actions of the ART to give full play to the advantages of intelligent control of the single vehicle, so as to perform the horizontal transportation operation efficiently. At the same time, ART control point optimization is performed on the basis of the global path planning, so that the dot matrix density can be reduced effectively, and the communication pressure of the network is alleviated greatly. As shown in FIG. 6, by arranging the allowed deviation range during right-angled turning of the ART, the vehicle is guided to perform the turning action autonomously. The above-mentioned process is primarily based on the own control logic and the kinematics characteristics of the ART, and the vehicle is allowed to plan the turning path, the passing speed and time and the like autonomously, so that the control communication pressure of the horizontal transportation system on the single vehicle is reduced.

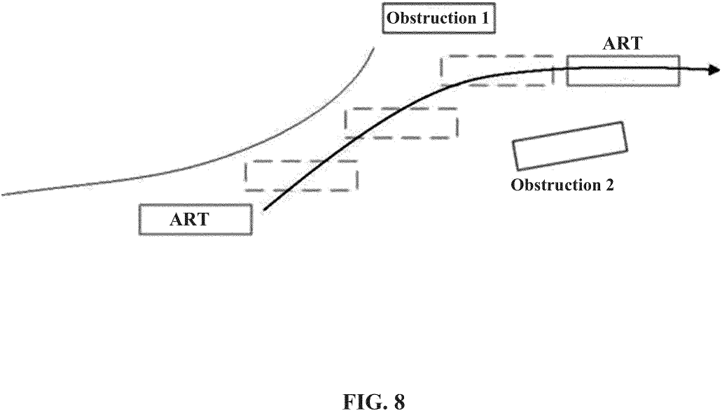

Based on detection devices such as monocular camera and radar carried by the ART, the single vehicle execution control refers to realization of autonomous lane changing, obstacle avoidance, speed control, parking and the like of the ART by utilizing the intelligent control algorithm based on a deep learning technology in combination with the kinematics characteristic of the vehicle itself, thereby guaranteeing the safety of the horizontal transportation operation. As shown in FIG. 7 to FIG. 8, in combination with conditions such as turning and obstacle avoidance in the actual transportation process, the ART constructs a SLAM model of a passing environment in real time by comprehensively applying various sensors carried by itself, and rationally selects a vehicle obstacle avoidance mode and path based on a single vehicle driving control algorithm. As shown in FIG. 7, the vehicle selects a static obstacle avoidance mode (the heading angle of the vehicle body changes, a part of tires deviate and the rest of tires are kept unchanged) in a right-angled turning scenario to realize turning pass of the vehicle. As shown in FIG. 8, the vehicle realizes autonomous obstacle avoidance in a crab walk passing mode (the heading direction of the vehicle body is kept unchanged, and all tires of the vehicle deviate at a same angle towards a same direction) when shying away from a plurality of obstacles.

The spatio-temporal consistent collision-free smooth path planning algorithm that supports the multi-kinematics model specifically comprises:

first, an evaluation function in an A-star algorithm is optimized according to the position information of the ART, then, key points are reserved by extracting key turning points and deleting redundant turning points to guarantee the optimum global path, and finally, the algorithm is fused into a dynamic window algorithm based on the kinetics characteristics of the vehicle to construct an evaluation function considering global optimum so as to realize real-time dynamic path planning of the vehicle.

A weight function of a heuristic function in the A-star algorithm is reset according to the position information of the ART, the evaluation function ƒ(n) being specifically represented as:

$$f \left(n\right) = g \left(n\right) + \left(1 + \frac{r}{R}\right) h \left(n\right) ;$$

where g(n) represents an exact cost of a path from a starting point to a node n, called a cost function; h(n) represents a heuristic estimated cost from the node n to the target, called a heuristic function; r is a distance from a current point to a target point, and R is a distance from the starting point to the target point; a global path obtained by the A-star algorithm is a one-time planned broken line path, and after the broken line path is obtained, the global path obtained by the A-start algorithm is the broken line path planned at one time, so that the operation speed and acceleration of the ART are unstable and do not comply with the kinematics characteristics of the ART, and therefore, there is a huge risk in the driving process of the transportation vehicle, easily resulting in the operation fault of the vehicle. The dynamic window algorithm can plan the dynamic smooth path in real time according to the key local path for operation of the ART to guarantee that the vehicle drives in a stable speed interval and the transportation process is smooth and stable. However, in the real-time dynamic environment, when the dynamic window algorithm is independently used, the ART easily deviates from the target path, which cannot meet the precision requirement on the path planning algorithm of the ART.

The improved A-star algorithm is integrated with the dynamic window algorithm, and the dynamic window evaluation function considering the global optimum path is designed specifically as follows:

$$G \left(v , w\right) = σ \left(α ⋅ P h e a d \left(v , w\right) + β ⋅ d i s t \left(v , w\right) + γ ⋅ v e l \left(v , w\right)\right)$$

where v represents a vehicle speed, w represents an angular speed of the vehicle, Phead(ν,w) simulates a deviation of an azimuth angle between an endpoint direction of a track and a current target point. The current target point is a sequence point of the global optimum path nearest to the current point in the advancing direction of the ART, dist(ν,w) represents the shortest distance from an obstacle on the track of the ART, vel (ν,w) represents the evaluation function for the current speed magnitude, σ is a normalization coefficient, and α, β, γ are weight coefficients; the local path planning follows the contour of the global optimum path through the improved evaluation function, so that the matching precision between the local path and the global path is improved.

A specific application process of the spatio-temporal consistent collision-free smooth path planning algorithm that supports the multi-kinematics model is as follows:

S210: data such as the driving speed, the path and the key pointof the current ART of the automatic container terminal are analyzed;

S212: a node data table and a path node data table are established in a path searching process of the A-star algorithm;

S213: evaluated function values of eight direction nodes around the starting point are respectively calculated by taking the starting point of the path as a current initial node;

S214: evaluation function calculated values of the current node and the eight direction nodes around are stored in a sub-node data table, and all nodes are arranged in an ascending order of the evaluation function values, and the node with the lowest calculated value is updated to the initial node and putting the initial node in the path node data table;

S215: current optimum node information on a planned path is stored in the path node data table, the path comprising the table being a preliminarily planed path;

S216: steps S212 to S215 are circularly executed until the endpoint is found out, where the path comprised in the path node data table is the global path planned by the A-star algorithm;

S217: based on the above-mentioned global path data, information of the driving speed and the steering angle of the ART in the key local path are extracted;

S218: secondary planning is implemented on the local path based on the dynamic window algorithm, so as to obtain the local planned paths, corresponding to different speeds in a next stage, of the ART;

S219: in combination with a kinematic model of the ART and a moving track thereof within a previous unit time, all the local paths and speeds of the ART in the next stage are evaluated by utilizing the dynamic window evaluation function that considers the global optimum path, and the optimum track and speed are selected as the driving plan of the current vehicle in the next stage.

The global path planning specifically comprises the following steps:

S201: a grid world is constructed in the driving road area of the ART in the terminal, and the starting point and the endpoint of the ART and the inevitable key points in the process that the ART drives from the starting point to the endpoint are annotated;

S202: select the shortest straight line path for the ART driving according to the starting point, the middle key point and the endpoint of the ART; in a shoreside operation area, the optimum topological relation is dynamically adjusted under a circumstance that the road is closed, and the structured road is generated offline according to obstacles in the site;

S203: the shortest path is fitted to the driving path according to the kinetic characteristics of the vehicle driving by grid line interpolation, and in the fitting process, the grid-level path is prioritized;

S204: in the driving process of the ART, in all scenarios, operation of the ART is cooperated first by a longitudinal speed planning method, so that multi-vehicle cooperative driving is realized.

P2.10: traffic deadlock prevention:

based on the real-time position and the driving speed of the vehicle, congestion of each traffic node is predicted in advance, and the driving speed and the path of the vehicle are adjusted timely, so as to solve the congestion problem of the key road section of the terminal.

P3: Standardized control interface:

a standard interface is defined based on an unmanned industry criterion to break through a tight coupling mode of the conventional automatic terminal. The standard interface is applied to the new generation full-automatic terminal field based on the unmanned driving technology to realize a decoupling design of the horizontal transportation device and the system, it is compatible with the horizontal transportation device with different kinematics characteristics in an unmanned technical route through the standard interface, and high-quality and high-concurrency real-time communication is realized by adopting an MQTT (Message Queuing Telemetry Transport) communication protocol base of the Internet of things; The specific functions are as follows:

P3.1: compatible with different transportation devices: the standard interface of the intelligent horizontal transportation device is designed to realize the decoupling design of the transportation device and the system so as to be compatible with the horizontal transportation devices based on different unmanned driving technologies.

P3.2: high-concurrency real-time communication: high-concurrency real-time communication is realized based on the high throughput communication base of the Internet of things.

P4: intelligent traffic management:

the positions and the number of outer container trucks are sensed by utilizing a vehicle infrastructure cooperation technology, the horizontal transportation device inside is positioned in real time and it is predicted through a Beidou high precision positioning technology, and spatial and temporal isolation of inside and outside vehicles s realized through a multipriority dynamic management and control strategy to realize intelligent traffic management of intersections of land transportation and shipping, so as to guarantee the operation safety, where the multi-priority-based dynamic management and control strategy is specifically as follows:

(1) The passing priority of the ART in the harbor district is higher than that of the outer container truck, and when the ART and the outer container truck converge to pass, the ART passes first;

(2) When the waiting time of the outer container truck is longer than 20 min or the number of the outer container trucks waiting for passing is greater than 3, the outer container trucks are forced to pass; the specific functions are as follows:

P4.1: vehicle real-time perception: the positions and the queueing number of the outer container trucks are perceived in real time based on a vehicle infrastructure cooperation technology, and the operation speed and position of the horizontal transportation device are perceived in real time based on real-time operation data;

P4.2: ART real-time prediction: the time when the ART arrives at the important traffic road section is predicted in real time based on information such as the horizontal transportation operational state, the driving speed and the position of the ART, whether congestion happens in the driving path of the vehicle is judged in advance, and the driving speed or path of the vehicle adjusted in real time;

P4.3: intelligent traffic management and control: through real-time perception of the outer container trucks and real-time prediction of the ARTs, the passing order of the outer container trucks are dynamically regulated and controlled on the premise of guaranteeing the priority of the ARTs based on the multi-priority dynamic management and control strategy to realize intelligent and humanized management of intersections and solve intersection congestion, so as to realize optimization of the overall horizontal transportation task; and

P4.4: humanized information prompting: passing information are prompted and guided in real time by utilizing an RFID, a high-speed road bar, a traffic light and an LED screen device installed at the intersection to facilitate the transportation operations of the outer container truck drivers.

P5: intelligent lock station management and control: based on a ground centralized lock disassembling and assembling process, one-key configuration is performed on the number of lock stations and the positions of the twist lock stations in combination with docking positions and a lock disassembling and assembling task, a lock disassembling and assembling task list are automatically generated according to historical operation data of ships, and the system selects the optimum lock island through a dynamic allocation algorithm to avoid congestion of the lock island, so as to ensure the lock disassembling and assembling operation efficiency; meanwhile, based on an intelligent safety management and control mechanism carried in a ground twist lock station, performing integral isolation of an automatic operation and a manual operation, so as to guarantee a safe and reliable lock disassembling and assembling operation; the specific functions are as follows:

P5.1: dynamic lock station arrangement: the number and the positions of the twist lock stations are dynamically set according to the loading and unloading operation quantities of the containers, a shore crane configuration plan and the length of the ship;

P5.2: autonomous path planning: the driving path of the horizontal transportation device is dynamically arranged according to the actual arrangement positions of the twist lock stations, so as to guarantee that a traffic flow in a twist lock station area will not form a dead point;

P5.3: intelligent twist lock station allocation: to guarantee balance of operations of the twist lock stations, based on the real-time operation conditions ofthem, the operation vehicles and the twist lock stations are dynamically allocated in real time by utilizing an intelligent allocation algorithm;

P5.4: lock disassembling and assembling task management: one key generation of a lock disassembling and assembling task list is performed according to the ship structure and the historical operation data, and double-person, four-person and intelligent lock disassembling and assembling robot operation modes are supported to assign tasks reasonably with convenient operations;

P5.5: twist lock station safety management and control: to ensure the safety of the manual lock disassembling and assembling operation, the safety state of the lock island is judged by utilizing a machine vision and position detected fusion perception method, and directly linking the horizontal transportation device for emergency brake in a non-safety state, so as to ensure the safety of personnel;

P5.6: automatic lock disassembling and assembling: full-automatic lock disassembling and assembling operation is performed by applying an intelligent lock disassembling and assembling robot to realize automatic operation of the lock station system in the complete flow, so as to improve the operation efficiency and guarantee the operation safety.

P6; intelligent vehicle reordering: based on a three-level horizontally arranged dynamic buffer area process, a sequential order of all horizontal transportation operation vehicles are regulated and controlled by utilizing advance scientific decision-making, interim differential control and post-operational temporary buffering in combination of a requirement on an actual shipping pattern, so as to guarantee that the transportation vehicles arrive an operation area of the shore crane according to a regulated operation order for orderly shipping operations, where the three-level horizontally arranged dynamic buffering process refers to dividing the buffering operational area of the ART into a storage yard operation buffering area, an operation buffering area under the shore crane and a twist lock station buffering area behind the shore crane. In the transportation process of the ART, the buffering area closest to the current ART is dynamically arranged according to a system scheduling command to execute the vehicle reordering task;

the specific functions are as follows:

P6.1: advance scientific decision-making: in the operation task scheduling and assigning processes, the priority of the task, the operation time of the device, and the position and the driving mileage of the horizontal transportation device are fully considered, so as to ensure a basic shipping operation sequence;

P6.2: interim differential control: in the driving process of the transportation vehicle, the possible sequential order of the vehicle is predicted according to the real-time traffic condition and dynamically adjusting the driving speed of the vehicle, so as to ensure that the vehicle arrives at the operation position as far as possible according to the given sequential order;

P6.3: post-operational temporary buffering: after failure of speed regulation and control, the sequential order of the horizontal transportation vehicle is regulated and controlled by utilizing a three-level buffering area of the twist lock station area;

P6.4: supporting various shipping modes: strict shipping, flexible shipping and free shipping modes are supported, and differential vehicle order adjusting methods are executed to fit the demands in different shipping modes;

P6.5: supporting a SuperTruck mode: to respond to temporary transportation task assignment, a SuperTruck vehicle transportation rule is executed, namely, an emergency transportation task and vehicle are set as the highest priority, the passing path and time of the vehicle are arranged, and the operation work of the task is completed within the shortest time, so as to respond to temporary transportation task assignment.

P7: intelligent charging scheduling: based on a centralized lateral side charging process, real-time decision-making is performed on charging opportunity and charging duration by utilizing a hierarchical dynamic charging scheduling strategy in combination with demands on transport capacity and power of a container horizontal transportation operation on the premise of fully considering mass charge-discharge balance, and a charging pile is selected in combination with the kinematics characteristics of the horizontal transportation device, and automatic alignment and automatic charging control are realized through a constructed charging pile device management platform, so as to ensure that overall power of the horizontal transportation vehicle is continuous and stable; the specific functions are as follows:

P7.1: hierarchical charging management: different vehicle charging strategies are executed according to the actual condition of a terminal operation, and overall charging and discharging equilibrium of a fleet is realized on the premise of completing the transportation tasks in time, so as to guarantee that the overall electric quantity of the fleet is maintained in a reasonable level;

P7.2: intelligent charging scheduling: intelligent management of vehicle charging is realized based on machine learning and big data analysis technologies, so as to reduce the number of charging times and protecting the service life of a battery.

P8: intelligent parking management: based on the horizontally arranged loading and unloading process, parking areas are dynamically arranged to fully utilize physical spaces in combination with a berth plan and a sealoading and unloading ship operation plan, and the parking areas and the positions are dynamically distributed in combination with the kinematics characteristics and future possible operation tasks of the vehicles to meet a fast attendance requirement, so as to improve the utilization ratios of the transportation vehicles and shorten the task waiting times; the specific functions are as follows:

P8.1: dynamically delineating a parking area: the parking area of the inner container trucks are dynamically adjusted and the transportation distances of the inner container trucks are shortened according to the actual operation condition of the terminal, so as to guarantee specific demands on re-entry and re-exit of a storage yard and shoreside loading and unloading; and

P8.2: intelligent parking lot adjustment: parking lots are scientifically set according to the kinematics characteristics of the vehicles, so as to meet a fast-in and fast-out requirement of the vehicles.

P9: intelligent remote driving: a standard control interface is defined, one-to-many remote driving of the horizontal transportation device is realized through a remote console based on the 5G high bandwidth and low delay ability, the horizontal transportation devices with different kinematics characteristics through the standard interface are compatible, and the intelligent horizontal transportation system is assisted to solve operational problems in special working conditions; the specific functions are as follows:

P9.1: real-time remote control: remote real-time supervision and control of the intelligent horizontal transportation devices are realized by the remote console based on a high bandwidth and low delay ability of the 5G network;

P9.2: one-to-many vehicle management and control: one-to-many remote management and control of the horizontal transportation device is realized through the remote console, so as to meet the operational demands in the special working conditions;

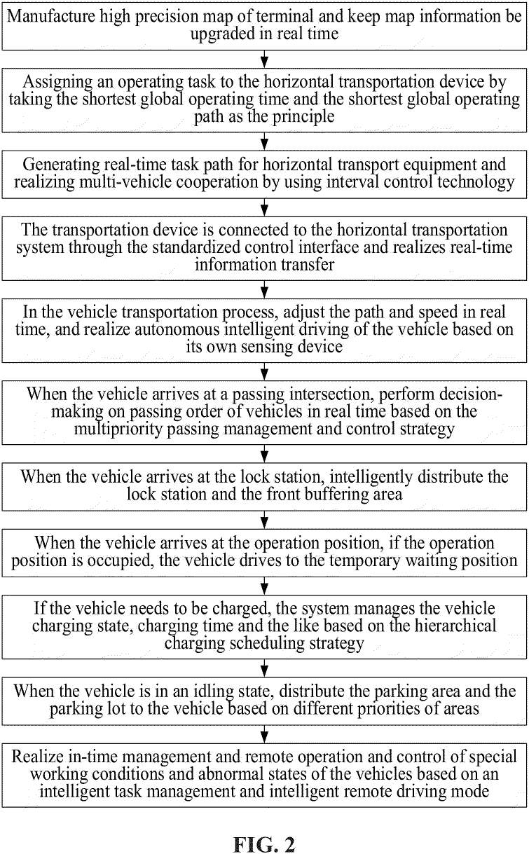

The intelligent horizontal transportation method for a completely automatic side-loading/unloading container terminal provided by an embodiment of the disclosure, as shown in FIG. 2, specifically comprises the following steps:

S1: terminal road information is acquired professionally and normally by the horizontal transportation control system by using a high precision mobile measurement device, a base map of a high precision map of a terminal is manufactured, and dynamic layers are constructed and real-time update is kept, so as to provide a basic environment for ART path planning and real-time monitoring;

S2: the horizontal transportation control system assigns an operation task to the horizontal transportation device in combination with a horizontal transportation operational plan comprising shipping and unshipping and container shifting and the like, and a real-time position of the horizontal transportation device by taking the shortest global operation time and the shortest global operation path as the principle;

S3: the horizontal transportation control system generates a real-time task path for the horizontal transportation device based on a dynamic path planning algorithm, determines the starting points and the endpoints of transportation tasks, realizes vehicle-vehicle cooperation in a key area by utilizing an interval vehicle control technology, and controls a traffic deadlock of a key path;

S4: the horizontal transportation device is connected to the horizontal transportation control system through a standardized control interface, reports the position and state of the horizontal transportation device itself, and receives an operation task and a driving path;

S5: in a vehicle driving process, the horizontal transportation control system performs dynamic path planning and speed adjustment on a vehicle based on the high precision map data of the terminal, the real-time position, the driving speed and the priority data of the vehicle. Meanwhile, the intelligent transportation vehicle autonomously completes obstacle avoiding, speed controlling and parking actions by utilizing sensing devices such as vehicle-mounted radar and a monocular camera to avoid risks initiatively, so as to complete the horizontal transportation task according to a regulated time and location;

S6: when the horizontal transportation device drives to a passing intersection of the outer container trucks located at entrance and exit of a storage yard, an intelligent traffic management module perceives the number and the positions of the outer container trucks in real time, and performs real-time decision-making on a passing order of the vehicles based on a multipriority passing management and control strategy;

S7: when the horizontal transportation vehicle advances for a twist lock station assembling and disassembling operation, the horizontal transportation control system assigns corresponding twist lock stations and front buffering areas for operation vehicles according to real-time working states of the twist lock stations, and meanwhile, plans driving paths of the vehicles in a twist lock station area, thereby ensuring safe operations in the lock assembling and disassembling processes by utilizing a safety management and control strategy;

S8: after completing the lock assembly and disassembly, the horizontal transportation control system schedules the horizontal transportation device or the vehicle to operation positions of a shore crane or the storage yard for shipping and unshipping operations, and when there are other vehicles in the operation positions, the horizontal transportation control system is responsible for assigning temporary waiting positions;

S9: during executing the horizontal transportation task or after completing the horizontal transportation task, a charging scheduling module evaluates whether the ART needs to be charged according to a hierarchical dynamic charging scheduling strategy, and if necessary, a charging system is responsible for enabling the ART to be automatically offline after completing the task, and automatically recovering the ART to be online after assigning charging piles to execute lateral side charging completely, so as to participate in the horizontal transportation operation continuously;

S10: when the vehicle completes the current operation task and has no subsequent planned tasks, the horizontal transportation control system is responsible for assigning the parking areas and the parking lots in combination with demands on a subsequent operation plan and fast attendance, and enabling the ART to be automatically offline;

S11: in all-weather dynamic monitoring of the intelligent transportation vehicles, the horizontal transportation control system realizes in-time management and remote operation and control of special working conditions and abnormal states of the vehicles based on an intelligent task management and intelligent remote driving mode.

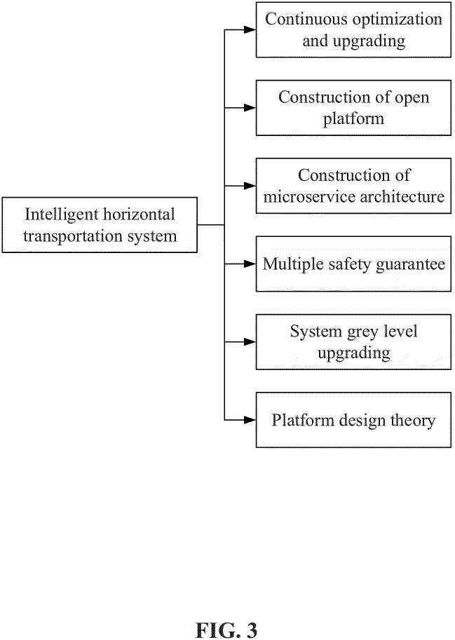

The intelligent horizontal transportation system provided by the embodiment of the disclosure, as shown in FIG. 3, has the following characteristics:

1, continuous optimization and upgrading: (1) under guarantee of an own core technical team, process innovation and whole process design are achieved; (2) a system architecture is continuously updated and iterated to construct a software ecosystem with lasting vitality;

2, construction of an open platform: (1) a standard interface is defined to achieve a decoupling design of the system and the transportation vehicle so as to support flexible model section of devices and be compatible with the transportation vehicles with different kinematics characteristics; (2) a universal communication base of the Internet of things is constructed to realize high-quality real-time communication and support high-concurrency application;

3, design of microservice architecture: (1) based on cloud base technical development, microservices and modular design, elastic expansion is supported; (2) a high performance microservice engine is deployed to be matched with Kubernetes container management and Istio service governance to realize concurrent calculation;

4, multiple safety guarantee: (1) identity authentication and safety authentication certificate management are designed to ensure access safety; (2) a multilayered key system is constructed to support full life cycle management of a key; (3) omnidirectional monitoring and defense are conducted to realize generic attach protection; (4) DDoS attacks of various network layers and application layers are protected in real time; and (5) all operations support and realize access control and log tracking;

5, system grey level upgrading: (1) DevOps agile development and grey level distribution are supported; (2) the system is continuously updated to support independent operations of high and low edition clusters; and (3) it is guaranteed that the system and algorithm upgrading processes do not interfere with operations and do not affect existing operation progress;

6, platform design theory: (1) key indexes of the horizontal transportation business are monitored and analyzed in real time by applying a KPI statistical analysis platform; (2) an alarm monitoring platform is deployed to report and alarm abnormalities of business operations in real time; (3) a fault recovery module is designed to rapidly judge a fault reason and process a fault so as to realize advance prediction, interim recovery, post-operational positioning and the like of the fault; (4) system logs are acquired in real time, and key information is rapidly searched and analyzed to realize health detection and prediction of the system; (5) the network and services are flexibly configured.

It will be obvious to those skilled in the art that changes and modifications may be made, and therefore, the aim in the appended claims is to cover all such changes and modifications.

What is claimed is:

1. An intelligent horizontal transportation system for a completely automatic side-loading/unloading container terminal, the system comprising a horizontal transportation device named artificial intelligence robot of transportation (ART) and a horizontal transportation control system that intelligently manages and controls the ART to enable the ART to complete horizontal transportation, wherein the horizontal transportation control system is in real-time connection and communication with a terminal operation system (TOS), an automatic field crane, an automatic shore crane and the ART to complete information interactive processing to realize information interconnection, so as to guarantee real-time utilization of information and intelligent control of the ART; the horizontal transportation control system realizes intelligent management and control of the horizontal transportation device by executing the following functions:
intelligent task scheduling: based on a horizontally arranged side-loading process, assigning an operating task to the horizontal transportation device in combination with a horizontal transportation operational plan comprising shipping and unshipping and container shifting, and a real-time position of the horizontal transportation device by taking a shortest global operating time and a shortest global operating path as the principle: first, generating a preliminary vehicle transportation path and a time schedule based on the principle of the shortest global operating time; and then correcting a part of path plan by applying the principle of the shortest global operating path and reducing road congestion in a harbor district so as to finally realize an optimum operating efficiency;
dynamic path planning: based on a horizontally arranged side-loading/unloading process, constructing a terminal road topological structure by utilizing a high definition map technology, planning a driving path of an operating vehicle in real time by applying a dynamic path planning algorithm in combination with real-time road information and kinematics characteristics: wide-angle turning and crab walk passing of the horizontal transportation device, and realizing vehicle-vehicle cooperation in a mode that combines global path planning and local refined guiding to solve a traffic deadlock problem, so as to ensure stable and orderly horizontal transportation;
control interface standardizing: defining a standard interface based on an unmanned industry criterion to realize a decoupling design of the horizontal transportation device and the system, being compatible with the horizontal transportation device with different kinematics characteristic in an unmanned technical route through the standard interface, and realizing real-time communication by adopting an MQTT (Message Queuing Telemetry Transport) communication protocol base of the Internet of things;
intelligent traffic management: sensing the positions and the number of outer container trucks by utilizing a vehicle infrastructure cooperation technology, positioning the horizontal transportation device inside in real time and predicting the position of the horizontal transportation device inside through a Beidou high precision positioning technology, and realizing spatial and temporal isolation of inside and outside vehicles through a multipriority dynamic management and control strategy to realize intelligent traffic management of intersections of land transportation and shipping, so as to guarantee the operating safety;
intelligent twist lock station management and control: based on a ground centralized lock disassembling and assembling process, performing one-key configuration on the number and the positions of twist lock stations in combination with docking positions and a lock disassembling and assembling task load, automatically generating a lock disassembling and assembling task list according to historical operating data of ships, and selecting the optimum lock island through a dynamic allocation algorithm to avoid congestion of the lock island, so as to ensure the lock disassembling and assembling operating efficiency; meanwhile, based on an intelligent safety management and control mechanism carried in a ground twist lock station, performing integral isolation of an automatic operation and a manual operation, so as to guarantee a safe and reliable lock disassembling and assembling operation;
intelligent vehicle reordering: based on a three-level horizontally arranged dynamic buffer area process, regulating and controlling a sequential order of all horizontal transportation operating vehicles by utilizing advance scientific decision-making, interim differential control and post-operational temporary buffering in combination of a requirement on an actual shipping pattern, so as to guarantee that the transportation vehicles arrive an operating area of the shore crane according to a regulated operating order for orderly shipping operations;
intelligent charging scheduling: based on a centralized lateral side charging process, performing real-time decision-making on charging opportunity and charging duration by utilizing a hierarchical dynamic charging scheduling strategy in combination with demands on transport capacity and power of a container horizontal transportation operation on the premise of fully considering mass charge-discharge balance, and selecting a charging pile in combination with the kinematics characteristics of the horizontal transportation device, and realizing automatic alignment and automatic charging control through a constructed charging pile device management platform, so as to ensure that overall power of the horizontal transportation vehicle is continuous and stable;
intelligent parking management: based on the horizontally arranged side loading and unloading process, dynamically arranging parking areas to fully utilize physical spaces in combination with a berth plan and a seaside loading and unloading ship operating plan, and dynamically distributing the parking areas and the parking positions in combination with the kinematics characteristics and future possible operating tasks of the vehicles to meet a fast attendance requirement, so as to improve the utilization ratios of the transportation vehicles and shorten the task waiting times;
intelligent remote driving: defining a standard control interface, being compatible with the horizontal transportation devices with different kinematics characteristics through the standard interface, realizing remote real-time supervision and control of the intelligent horizontal transportation devices by a remote console based on the 5G high bandwidth and low delay ability, and realizing one-to-many remote driving supervision and monitoring of the horizontal transportation devices through the remote console.

2. The intelligent horizontal transportation system of claim 1, wherein the intelligent task scheduling realizes the following functions:
ART real-time monitoring: dynamically acquiring the horizontal transportation operational plan comprising shipping and unshipping and container shifting, and monitoring the operating states, the driving positions and the driving speeds of all ART in the harbor district in real time; and
ART intelligent scheduling: screening unoccupied ARTs with sufficient surplus electric quantities in the harbor district, and assigning a transportation task to each of the ARTs based on a principle of the shortest total driving time; and meanwhile, under the principle of reducing congestion of a road network in the harbor district, planning a route with the shortest driving distance to each of ARTs.

3. The intelligent horizontal transportation system of claim 1, wherein the dynamic route planning has the following functions:
high precision map manufacturing: acquiring information by using a high precision mobile measurement device, and completing manufacturing of a high precision map in a dynamic complex environment of a terminal based on a map generating algorithm and a flow, the traverse absolute precision reaching 20 cm;
dynamic layer management: integrating real-time dynamic map information of the terminal by taking the high precision map as a base map to construct a dynamic map management ability, increasing a plurality of dynamic layers on the base map, and drawing information with different updating frequencies to different dynamic layers and keeping real-time refreshing to describe a dynamic traffic environment, the path planning layer increased on the base map being used for describing an attribute and a passing rule of each passing area;
dynamic road network topology: under a circumstance of alternation of the road topological structure in the harbor district, constructing the optimum topological relation of the road by utilizing a dynamic path generating algorithm meeting a site condition, setting the optimum path of the ART in a scenario of an unstructured harbor district in real time, and providing real-time basic road information to the path generating algorithm, so as to guarantee centimeter-level vehicle cooperative management;
intelligent path planning: based on the dynamic road network topological structure, dynamically planning a driving path in real time by utilizing a spatio-temporal consistent collision-free smooth path planning algorithm that supports a multi-kinematics model in combination with the kinematics characteristics of the horizontal transportation device and traffic actuality; meanwhile, in combination with the global operation scheduling, the global path planning, the local refined guiding and single vehicle execution control, defining a key interval from the God’s perspective of the intelligent horizontal transportation system, setting a suggested speed, a time window and the maximum range in an allowable deviation of the key interval in combination with the kinematics characteristics of the single vehicle to form an automatic driving route to solve the traffic deadlock in the key area comprising the intersections of the paths, so as to meet a transportation operational demand of the ART; and
traffic deadlock prevention: based on the real-time position and the driving speed of the vehicle, predicting congestion of each traffic node in advance, and adjusting the driving speed and the path of the vehicle timely, so as to solve the congestion problem of the key road section of the terminal,
the spatio-temporal consistent collision-free smooth path planning algorithm that supports the multi-kinematics model specifically comprises:
first, optimizing an evaluation function in an A-star algorithm according to the position information of the ART, then, reserving key points by extracting key turning points and deleting redundant turning points to guarantee the optimum global path, and finally, integrating the algorithm into a dynamic window algorithm based on the kinetics characteristics of the vehicle to construct an evaluation function considering global optimum so as to realize real-time dynamic path planning of the vehicle;
setting a weight function of a heuristic function in the A-star algorithm according to the position information of the ART, the evaluation function ƒ(n) being specifically represented as:
$$f \left(n\right) = g \left(n\right) + \left(1 + \frac{r}{R}\right) h \left(n\right) ;$$
wherein g(n) represents an exact cost of a path from a starting point to a node n, called a cost function; h(n) represents a heuristic estimated cost from the node n to a target, called a heuristic function; r is a distance from a current point to a target point, and R is a distance from the starting point to the target point; a global path obtained by the A-star algorithm is a one-time planned broken line path, and after the broken line path is obtained, the dynamic window algorithm and the A-start algorithm are combined to plan a dynamic smooth path in real time according to a key local path for operation of the ART, so that it is guaranteed that the vehicle drives in a stable speed interval and the transportation process is smooth and stable;
the improved A-star algorithm is integrated with the dynamic window algorithm, and the dynamic window evaluation function considering the global optimum path is designed specifically as follows:
$$G \left(v , w\right) = σ \left(α ⋅ P h e a d \left(v , w\right) + β ⋅ d i s t \left(v , w\right) + γ ⋅ v e l \left(v , w\right)\right)$$
wherein ν represents a vehicle speed, w represents an angular speed of the vehicle, P head e (ν, w) simulates a deviation of an azimuth angle between an endpoint direction of a track and a current target point, and the current target point is a sequence point of the global optimum path nearest to the current point in the advancing direction of the ART, dist(ν,w) represents the shortest distance from an obstacle on the track of the ART, vel(ν,w) represents the evaluation function for the current speed magnitude, σ is a normalization coefficient, and α, β, γ are weight coefficients; the local path planning follows the contour of the global optimum path through the improved evaluation function, so that the matching precision between the local path and the global path is improved;
a specific application process of the spatio-temporal consistent collision-free smooth path planning algorithm that supports the multi-kinematics model comprises:
S210: analyzing the driving speed, the path and the key point data of the current ART;
S212: establishing a node data table and a path node data table in a path searching process of the A-star algorithm;
S213: respectively calculating evaluated function values of eight direction nodes around the starting point by taking the starting point of the path as a current initial node;
S214: storing evaluation function calculated values of the current node and the eight direction nodes around in a sub-node data table, and arranging all nodes in an ascending order of the evaluation function values, and updating the node with the lowest calculated value to the initial node and putting the initial node in the path node data table;
S215: storing current optimum node information on a planned path in the path node data table, the path comprising the table being a preliminarily planed path;
S216: circularly executing steps S212 to S215 till finding out the endpoint, where the path included in the path node data table is the global path planned by the A-star algorithm;
S217: based on the above-mentioned global path data, extracting information of the driving speed and the steering angle of the ART in the key local path;
S218: implementing secondary planning on the local path based on the dynamic window algorithm, so as to obtain the local planned paths, corresponding to different speeds in a next stage, of the ART; and
S219: in combination with a kinematic model of the ART and a moving track thereof within a previous unit time, evaluating all the local paths and speeds of the ART in the next stage by utilizing the dynamic window evaluation function that considers the global optimum path, and selecting the optimum track and speed as the driving plan of the current vehicle in the next stage.

4. The intelligent horizontal transportation system of claim 1, wherein the intelligent traffic management comprises the following functions:
ART real-time prediction: positioning the ART in real time based on the Beidou high precision positioning technology, predicting the time when the ART arrives at the target traffic road section based on the horizontal transportation operational state, the driving speed and the position information, judging whether congestion happens in the driving path of the vehicle in advance, and adjusting the driving speed or path of the vehicle in real time;
intelligent traffic management and control: through real-time perception of the outer container trucks and real-time prediction of the ARTs, dynamically regulating and controlling the passing order of the outer container trucks on the premise of guaranteeing the priority of the ARTs based on the multi-priority dynamic management and control strategy to realize intelligent and humanized management of intersections and solve intersection congestion, so as to realize optimization of the overall horizontal transportation task; and
humanized information prompting: prompting and guiding passing information in real time by utilizing an RFID, a high-speed road bar, a traffic light and an LED screen device installed at the intersection to facilitate the transportation operations of the outer container truck drivers.

5. The intelligent horizontal transportation system of claim 1, wherein the intelligent lock station management and control comprises the following functions:
dynamic lock station arrangement: dynamically setting the number and the positions of the twist lock stations according to the loading and unloading operation quantities of the containers, a shore crane configuration plan and a length of the ship;
autonomous path planning: dynamically arranging the driving path of the horizontal transportation device according to the actual arrangement positions of the lock stations, so as to guarantee that a traffic flow in a twist lock station area will not form a dead point;
intelligent twist lock station allocation: based on the real-time operation conditions of the twist lock stations, dynamically allocating the operation vehicles and the twist lock stations in real time by utilizing an intelligent allocation algorithm, so as to guarantee balance of operations of the twist lock stations;
lock disassembling and assembling task management: performing one key generation of a lock disassembling and assembling task list according to the ship structure and the historical operation data, and supporting double-person, four-person and intelligent lock disassembling and assembling robot operation modes to assign tasks reasonably;
twist lock station safety management and control: judging the safety state of the lock island by utilizing a machine vision and position detected fusion perception method, and directly linking the horizontal transportation device for emergency brake in a non-safety state, so as to ensure the safety of personnel; and
automatic lock disassembling and assembling: performing full-automatic lock disassembling and assembling operation by applying an intelligent lock disassembling and assembling robot to realize automatic operation of the twist lock station system in the complete flow, so as to improve the operation efficiency and guarantee the operation safety.

6. The intelligent horizontal transportation system of claim 1, wherein the intelligent vehicle reordering comprises the following functions:
advance scientific decision-making: in the operation task scheduling and assigning processes, fully considering the priority of the task, the operation time of the device, and the position and the driving mileage of the horizontal transportation device, so as to ensure a basic shipping operation sequence;
interim differential control: in the driving process of the transportation vehicle, predicting the possible sequential order of the vehicle according to the real-time traffic condition and dynamically adjusting the driving speed of the vehicle, so as to ensure that the vehicle arrives at the operation position according to the given sequential order;
post-operational temporary buffering: after failure of speed regulation and control, regulating and controlling the sequential order of the horizontal transportation vehicle by utilizing a three-level buffering area of the twist lock station area;
supporting various shipping modes: supporting strict shipping, flexible shipping and free shipping modes, and executing differential vehicle order adjusting methods to fit the demands in different shipping modes; and
supporting a SuperTruck mode: executing a SuperTruck vehicle transportation rule, namely, setting an emergency transportation task and vehicle as the highest priority, arranging the passing path and time of the vehicle, and completing the operation work of the task within the shortest time, so as to respond to temporary transportation task assignment.

7. The intelligent horizontal transportation system of claim 1, wherein the intelligent charging scheduling comprises the following functions:
hierarchical charging management: executing different vehicle charging strategies according to the actual condition of a terminal operation, and realizing overall charging and discharging equilibrium of a fleet on the premise of completing the transportation tasks in time, so as to guarantee that the overall electric quantity of the fleet is maintained in a reasonable level; and
intelligent charging scheduling: realizing intelligent management of vehicle charging based on machine learning and big data analysis technologies, so as to reduce the number of charging times and protecting the service life of a battery.

8. The intelligent horizontal transportation system of claim 1, wherein the intelligent parking management comprises the following functions:
dynamically delineating a parking area: dynamically adjusting the parking area of the inner container trucks and shortening the transportation distances of the inner container trucks according to the actual operation condition of the terminal, so as to guarantee specific demands on re-entry and re-exit of a storage yard and shoreside loading and unloading; and
intelligent parking lot adjustment: intelligently adjusting parking lots according to the kinematics characteristics of the vehicles, so as to meet a fast-in and fast-out requirement of the vehicles.

9. An intelligent horizontal transportation method for a completely automatic loading and unloading container terminal using the intelligent horizontal transportation system according to claim 1, the method comprising the following steps:
S1: acquiring terminal road information by a horizontal transportation control system by using a high precision mobile measurement device, manufacturing a base map of a high precision map of a terminal, and constructing dynamic layers and keeping real-time update, so as to provide a basic environment for ART path planning and real-time monitoring;
S2: assigning an operation task to the horizontal transportation device in combination with a horizontal transportation operational plan comprising shipping and unshipping and container shifting, and a real-time position of the horizontal transportation device by the horizontal transportation control system by taking the shortest global operation time and the shortest global operation path as the principle;
S3: generating, by the horizontal transportation control system, a real-time task path for the horizontal transportation device based on a dynamic path planning algorithm, determining the starting points and the endpoints of transportation tasks, realizing vehicle-vehicle cooperation in a key area by utilizing an interval vehicle control technology, and controlling a traffic deadlock of a key path;
S4: connecting the horizontal transportation device to the horizontal transportation control system through a standardized control interface, reporting the position and state of the horizontal transportation device itself, and receiving an operation task and a driving path;
S5: in a vehicle driving process, performing, by the horizontal transportation control system, dynamic path planning and speed adjustment on a vehicle based on the high precision map data of the terminal, the real-time position, the driving speed and the priority data of the vehicle, and meanwhile, autonomously completing, by the horizontal transportation device, obstacle avoiding, speed controlling and parking actions by utilizing sensing devices comprising vehicle-mounted radar and a monocular camera to avoid risks initiatively, so as to complete the horizontal transportation task according to a regulated time and location;
S6: when the horizontal transportation device drives to a passing intersection of the outer container trucks located at entrance and exit of a storage yard, perceiving the number and the positions of the outer container trucks in real time, and performing real-time decision-making on a passing order of the vehicles based on a multipriority passing management and control strategy;
S7: when the horizontal transportation device advances for a twist lock station assembling and disassembling operation, assigning corresponding twist lock stations and front buffering areas for operation vehicles according to real-time working states of the twist lock stations, and meanwhile, planning driving paths of the vehicles in a twist lock station area, and ensuring safe operations in the lock assembling and disassembling processes by utilizing a safety management and control strategy;
S8: after completing the lock assembly and disassembly, scheduling, by the horizontal transportation control system, the horizontal transportation device to operation positions of a shore crane or the storage yard for shipping and unshipping operations, and when there are other vehicles in the operation positions, assigning, by the horizontal transportation control system, temporary waiting positions;
S9: during executing the horizontal transportation task or after completing the horizontal transportation task, evaluating whether the ART needs to be charged according to a hierarchical dynamic charging scheduling strategy, and if necessary, enabling, by a charging system, the ART to be automatically offline after completing the task, and automatically recovering the ART to be online after assigning charging piles to execute lateral side charging completely, so as to participate in the horizontal transportation operation continuously;
S10: when the vehicle completes the current operation task and has no subsequent planned tasks, assigning, by the horizontal transportation control system, the parking areas and the parking lots in combination with demands on a subsequent operation plan and fast attendance, and enabling the ART to be automatically offline; and
S11: in all-weather dynamic monitoring of the intelligent transportation vehicles, realizing, by the horizontal transportation control system, in-time management and remote operation and control of special working conditions and abnormal states of the vehicles based on an intelligent task management and intelligent remote driving mode.
